(19) United States
(12) Patent Application Publication
(10) Pub. No.: US 2023/0224502 A1
(43) Pub. Date: Jul. 13, 2023

(54) PROVIDING SEMANTIC INFORMATION WITH ENCODED IMAGE DATA

(71) Applicant: Telefonaktiebolaget LM Ericsson (publ), Stockholm (SE)

(72) Inventors: Mitra DAMGHANIAN, Upplands-Bro (SE); Christopher HOLLMANN, UPPSALA (SE)

(73) Assignee: Telefonaktiebolaget LM Ericsson (publ), Stockholm (SE)

(21) Appl. No.: 18/009,292

(22) PCT Filed: Jun. 9, 2021
(86) PCT No.: PCT/SE2021/050552

§ 371 Date: Dec. 8, 2022

Related U.S. Application Data
(60) Provisional application No. 63/036,620, filed on Jun. 9, 2020.

(51) Int. Cl. H04N 19/70; H04N 19/46; H04N 19/169

(52) U.S. Cl. CPC H04N 19/70; H04N 19/46; H04N 19/188

(57) ABSTRACT

A method (400) performed by a decoder. The method includes the decoder receiving (s402) a plurality of Network Abstraction Layer, NAL, units, wherein the plurality of NAL units comprises: i) one or more Video Coding Layer, VCL, NAL units comprising pixel data for one or more pictures and ii) a first non-VCL NAL unit, characterized in that the first non-VCL NAL unit comprises: i) at least a first syntax element identifying at least a first data type, DT1, and ii) semantic information that comprises at least a first feature for one or more machine vision tasks, wherein the first feature comprises at least first data of the first data type. The method also includes the decoder obtaining (s404) the first feature from the first non-VCL NAL unit.

### TECHNICAL FIELD

Disclosed are embodiments related to providing semantic information with encoded image data (e.g., video data).

### BACKGROUND

1. Video Compression

A video (a.k.a., video sequence) consists of a series of images (a.k.a., pictures or frames) where each image consists of one or more components. Each component can be described as a two-dimensional rectangular array of sample values. It is common that an image in a video sequence consists of three components; one luma component Y where the sample values are luma values and two chroma components Cb and Cr, where the sample values are chroma values. Components are sometimes referred to as “color components.”

Video is already the dominant form of data traffic in today's networks and is projected to still increase its share (see reference [4]). One way to reduce the data traffic per video is compression. Here the source video is encoded to a bitstream, which then can be stored and transmitted to end users. Using a decoder, the end user can extract the video data and display it on a screen. However, since the encoder does not know what kind of device the encoded bitstream is going to be sent to, it has to compress the video to a standardized format. Then all devices which support the chosen standard can decode the video. Compression can be lossless, i.e. the decoded video will be identical to the source given to the encoder, or lossy, where a certain degradation of content is accepted. This has a significant impact on the bitrate, i.e. how high the compression ratio is, as factors such as noise can make lossless compression quite expensive.

2. Commonly Used Video Coding Standards

Video standards are usually developed by international organizations as these represent different companies and research institutes with different areas of expertise and interests. The currently most applied video compression standard is H.264/AVC which was jointly developed by ITU-T and ISO. The first version of H.264/AVC was finalized in 2003, with several updates in the following years. The successor of H.264/AVC, which was also developed by ITU-T and ISO, is known as H.265/HEVC and was finalized in 2013. Currently, the successor of HEVC is being developed, with a finalization date of mid-2020. This new codec has the nickname Versatile Video Coding (VVC).

3. NAL Units

Both HEVC and VVC define a Network Abstraction Layer (NAL). All the data, i.e. both Video Coding Layer (VCL) or non-VCL data in HEVC and VVC is encapsulated in NAL units. A VCL NAL unit contains data that represents image sample values. A non-VCL NAL unit contains additional associated data such as parameter sets and supplemental enhancement information (SEI) messages. The NAL unit in HEVC begins with a header which specifies the NAL unit type of the NAL unit that identifies what type of data is carried in the NAL unit, the layer ID and the temporal ID for which the NAL unit belongs to. The NAL unit type is transmitted in the nal_unit_type codeword in the NAL unit header and the type indicates and defines how the NAL unit should be parsed and decoded. The rest of the bytes of the NAL unit is payload of the type indicated by the NAL unit type. A bitstream consists of a series of concatenated NAL units.

The syntax for the NAL unit header for HEVC and VVC are shown in

Table 1 and 2, respectively.

TABLE 1
HEVC NAL unit header syntax

| | Descriptor |
|---|---|
| nal_unit_header( ) { | |
| forbidden_zero_bit | f(1) |
| nal_unit_type | u(6) |
| nuh_layer_id | u(6) |
| nuh_temporal_id_plus1 | u(3) |
| } | |

TABLE 2
VVC NAL unit header syntax

| | Descriptor |
|---|---|
| nal_unit_header( ) { | |
| forbidden_zero_bit | f(1) |
| nuh_reserved_zero_bit | u(1) |
| nuh_layer_id | u(6) |
| nal_unit_type | u(5) |
| nuh_temporal_id_plus1 | u(3) |
| } | |

The NAL unit types of the current VVC draft are shown in

Table 3.

The decoding order is the order in which NAL units shall be decoded, which is the same as the order of the NAL units within the bitstream. The decoding order may be different from the output order, which is the order in which decoded images are to be output, such as for display, by the decoder.

TABLE 3
NAL unit types in VVC

| | Name of | Content of NAL unit and raw byte sequence | NAL unit |
|---|---|---|---|
| nal_unit_type | nal_unit_type | payload (RBSP) syntax structure | type class |
| 0 | TRAIL_NUT | Coded slice of a trailing picture | VCL |
| | | slice_layer_rbsp( ) | |
| 1 | STSA_NUT | Coded slice of an STSA picture | VCL |
| | | slice_layer_rbsp( ) | |
| 2 | RADL_NUT | Coded slice of a RADL picture | VCL |
| | | slice_layer_rbsp( ) | |
| 3 | RASL_NUT | Coded slice of a RASL picture | VCL |
| | | slice_layer_rbsp( ) | |
| 4 . . . 6 | RSV_VCL_4 . . . | Reserved non-IRAP VCL NAL unit types | VCL |
| | RSV_VCL_6 | | |
| 7 | IDR_W_RADL | Coded slice of an IDR picture | VCL |
| 8 | IDR_N_LP | slice_layer_rbsp( ) | |
| 9 | CRA_NUT | Coded slice of a CRA picture | VCL |
| | | silce_layer_rbsp( ) | |
| 10 | GDR_NUT | Coded slice of a GDR picture | VCL |
| | | slice_layer_rbsp( ) | |
| 11 | RSV_IRAP_11 | Reserved IRAP VCL NAL unit types | VCL |
| 12 | RSV_IRAP_12 | | |
| 13 | DCI_NUT | Decoding capability information | non-VCL |
| | | decoding_capability_information_rbsp( ) | |
| 14 | VPS_NUT | Video parameter set | non-VCL |
| | | video_parameter_set_rbsp( ) | |
| 15 | SPS_NUT | Sequence parameter set | non-VCL |
| | | seq_parameter_set_rbsp( ) | |
| 16 | PPS_NUT | Picture parameter set | non-VCL |
| | | pic_parameter_set_rbsp( ) | |
| 17 | PREFIX_APS_NUT | Adaptation parameter set | non-VCL |
| 18 | SUFFIX_APS_NUT | adaptation_parameter_set_rbsp( ) | |
| 19 | PH_NUT | Picture header | non-VCL |
| | | picture_header_rbsp( ) | |
| 20 | AUD_NUT | AU delimiter | non-VCL |
| | | access_unit_delimiter_rbsp( ) | |
| 21 | EOS_NUT | End of sequence | non-VCL |
| | | end_of_seq_rbsp( ) | |
| 22 | EOB_NUT | End of bitstream | non-VCL |
| | | end_of_bitstream_rbsp( ) | |
| 23 | PREFIX_SEI_NUT | Supplemental enhancement information | non-VCL |
| 24 | SUFFIX_SEI_NUT | sei_rbsp( ) | |
| 25 | FD_NUT | Filler data | non-VCL |
| | | filler_data_rbsp( ) | |
| 26 | RSV_NVCL_26 | Reserved non-VCL NAL unit types | non-VCL |
| 27 | RSV_NVCL_27 | | |
| 28 . . . 31 | UNSPEC_28 . . . | Unspecified non-VCL NAL unit types | non-VCL |
| | UNSPEC_31 | | |

4. Picture Order Count

Pictures in HEVC and VVC are identified by their picture order count (POC) values. Both encoder and decoder keep track of POC and assign POC values to each picture that is encoded/decoded. POC is expected to work in a similar way in the final version of VVC.

5. SEI Messages

Supplementary Enhancement Information (SEI) messages are codepoints in the coded bitstream that do not influence the decoding process of coded pictures from VCL NAL units. SEI messages usually address issues of representation/rendering of the decoded bitstream. The overall concept of SEI messages and many of the messages themselves have been inherited from the H.264 and HEVC specifications into VVC specifications. In the current version of VVC, an SEI RBSP contains one or more SEI messages.

SEI message syntax table describing the general structure of an SEI message in the current VVC draft is shown in

Table 4.

TABLE 4
SEI message syntax table in the current VVC draft

| | Descriptor |
|---|---|
| sei_message( ) { | |
| payloadType = 0 | |
| do { | |
| payload_type_byte | u(8) |
| payloadType += payload_type_byte | |
| } while( payload_type_byte = = 0xFF ) | |
| payloadSize = 0 | |
| do { | |
| payload_size_byte | u(8) |
| payloadSize += payload_size_byte | |
| } while( payload_size_byte = = 0xFF ) | |
| sei_payload( payloadType, payloadSize ) | |
| } | |

Annex D in JVET-R2001-v8 (see reference [1]), the current version of the VVC, specifies syntax and semantics for SEI message payloads for some SEI messages, and specifies the use of the SEI messages and VUI parameters for which the syntax and semantics are specified in ITU-T H.SEI ISO/IEC 23002-7.

SEI messages assist in processes related to decoding, display, or other purposes. SEI messages, however, are not required for constructing the luma or chroma samples by the decoding process. Some SEI messages are required for checking bitstream conformance and for output timing decoder conformance. Other SEI messages are not required for checking bitstream conformance. A decoder is not required to support all SEI messages. Usually, if a decoder encounters an unsupported SEI message, it is discarded.

ITU-T H.SEI ISO/IEC 23002-7 specifies the syntax and semantics of SEI messages and is particularly intended for use with coded video bitstreams, although it is drafted in a manner intended to be sufficiently generic that it may also be used with other types of coded video bitstreams. JVET-R2007-v2 (see reference [2]) is the current draft that specifies the syntax and semantics of VUI parameters and SEI messages for use with coded video bitstreams.

The persistence of an SEI message indicates the pictures to which the values signalled in the instance of the SEI message may apply. The part of the bitstream to which the values of the SEI message may apply are referred to as the persistence scope of the SEI message.

Table 5 summarizes the currently existing SEI messages in references Error! Reference source not found. and Error! Reference source not found. and their associated persistence scope.

TABLE 5
SEI messages in [1] and [2] and their associated persistence scope

| # | SEI message | Persistence scope |
|---|---|---|
| 1 | Buffering period | The remainder of the bitstream |
| 2 | Picture timing | The AU containing the SEI message |
| 3 | DU information | The AU containing the SEI message |
| 4 | Scalable nesting | Depending on the scalable-nested SEI |
| | | messages. Each scalable-nested SEI |
| | | message has the same persistence scope |
| | | as if the SEI message was not scalable- |
| | | nested |
| 5 | Subpicture level | The CLVS containing the SEI message |
| | information | |
| 6 | Filler payload | The AU containing the SEI message |
| 7 | User data registered by | Unspecified |
| | Rec. ITU-T T.35 | |
| 8 | User data unregistered | Unspecified |
| 9 | Film grain | Specified by the syntax of the SEI message |
| | characteristics | |
| 10 | Frame packing | Specified by the syntax of the SEI message |
| | arrangement | |
| 11 | Referenced parameter | The CLVS containing the SEI message |
| | sets | |
| 12 | Decoded picture hash | The PU containing the SEI message |
| 13 | Mastering display | The CLVS containing the SEI message |
| | colour volume | |
| 14 | Content light level | The CLVS containing the SEI message |
| | information | |
| 15 | DRAP indication | The AU containing the SEI message |
| 16 | Alternative transfer | The CLVS containing the SEI message |
| | characteristics | |
| 17 | Ambient viewing | The CLVS containing the SEI message |
| | environment | |
| 18 | Content colour volume | Specified by the syntax of the SEI message |
| 19 | Equirectangular | Specified by the syntax of the SEI message |
| | projection | |
| 20 | Generalized cubemap | Specified by the syntax of the SEI message |
| | projection | |
| 21 | Sphere rotation | Specified by the syntax of the SEI message |
| 22 | Region-wise packing | Specified by the syntax of the SEI message |
| 23 | Omnidirectional | Specified by the syntax of the SEI message |
| | viewport | |
| 24 | Frame-field | The AU containing the SEI message |
| | information | |
| 25 | Sample aspect ratio | Specified by the syntax of the SEI message |
| | information | |

6. Machine Vision Tasks

Machine vision is a technology that is often used in industrial applications. In general, machine vision applications take input from a sensor, usually a camera, perform some sort of processing and provide an output. The scope of applications is very wide, ranging from barcode scanners via product inspection at assembly lines and augmented reality applications for phones to decision making in self-driving cars.

The processing in machine vision applications can be done by very different algorithms running on different hardware set-ups. In certain applications, a simple digital signal processor might suffice, whereas in other cases one or more graphics processing units are required. In recent years, processing the input with neural networks has gained strong attraction due to the versatility of neural networks.

The result produced by the processing algorithm can also vary quite much. A barcode scanner in a store could give you a product number, a product inspection system might tell whether a product is faulty, an augmented reality application on a phone could give you a filtered picture with additional information, and an algorithm in a self-driving car might give you an indication whether you need to reduce speed or not.

There are many different tasks that can be performed by machine vision algorithms, for example: a) Object detection where objects in the input image or video are located corresponding to their position and size; it is also possible to extract information about the nature of the detected objects, and his can for example be used in automated tagging of image databases; b) Object tracking—based on the object detection task, objects are traced through different frames of the input video; an example application is a surveillance system in a store that tracks the movement of customers; c) Object segmentation—an image or video is divided into different regions, with regions being easier to analyze or process (e.g., applications that replace the background in a video stream use segmentation); and d) Event detection—based on the input, the algorithm determines if there is a certain type of event happening, for example fire detection in rural or forest areas.

7. Video Coding for Machines (VCM)

In 2019, the Moving Picture Experts Group (MPEG) of ISO started an exploration into the area of Video Coding for Machines (VCM). A VCM encoder may get its input from a sensor, e.g. a camera and the output of the camera is encoded using a traditional video codec like HEVC or VVC. The sensor data may also be subjected to a feature extraction process that produces one or more features. In some cases, the format of the features needs to be converted into a format that a feature encoder can handle, while in most cases the features are directly passed on to the feature encoder. This feature encoder converts the feature data into a feature bitstream, which is then multiplexed with the compressed video bitstream produced by the video codec. After transmission, a receiving system demultiplexes the combined bitstreams into the individual video bitstream and the individual feature bitstream. The video bitstream is then decoded using an appropriate video decoder for the chosen codec. The decoded video can then be used for human vision tasks like displaying video on a screen. The feature bitstream is decoded by a feature decoder. The decoded features can then be used to either display additional information for human vision tasks or be used for machine vision tasks.

8. Features and Data Types

In the context of VCM, the data extracted from a video frame or image is referred to as a feature. This extraction process can for example be performed by a neural network. How a feature is described depends on the task or tasks the network is trained to perform. The following is an incomplete list of how features may be described for different tasks:

a) For object detection: a list of bounding boxes, each indicating position and size of an object. Furthermore, an identifier might be included to describe the type of each detected object;
b) For object tracking: a list of bounding boxes, each indicating position and size of an object; furthermore, an identifier might be included to describe the type of each detected object, and each bounding box may furthermore contain an object identifier which is unique to the specific object and stays the same during multiple frames;
c) For object segmentation: a matrix of the same size as the input image or video frame, with each element being an identifier, which can be mapped to a class of objects;
d) For event detection: a label, describing the event or an identifier, mapping the event to a list of possible events defined outside the scope of VCM (alternatively, the data type might be a timestamp indicating the occurrence of the event); and
e) For event prediction: a label, describing the event or an identifier, mapping the event to a list of possible events defined outside the scope of VCM (alternatively, the data type might be a timestamp indicating the predicted occurrence of the event).

The data types of features can overlap, so it is possible that different features have the same data types. For example, both event detection and event prediction use at least partially the same data type. It is also possible that the data type of one feature is a subset of a different feature. The data type used for object detection can for example be a subset of the data type used for object tracking, as the latter contains the same information and additionally an identifier to track objects through multiple frames.

9. Prior Work

Reference [5] focuses on carrying data for Compact Descriptors for Video Analysis (CDVA), a previous MPEG standard (ISO/JEC 15938-15). The CDVA descriptor has been defined by MPEG for video analysis purposes with typical tasks such as video search and video retrieval. CDVA is developed based on another MPEG standard, Compact Descriptors for Visual Search (CDVS) for still images. In CDVS and CDVA, local descriptors capture the invariant characteristics of local image patches and the global descriptors reflect the aggregated statistics of local descriptors.

Reference [7] describes an annotated region (AR) SEI message, which was first proposed to HEVC in April 2018. Reference [7] discloses that a bounding box can be sent in a video bitstream as metainformation, providing the decoder with the information where an object within the frame can be found. The described SEI message also uses persistent parameters to avoid signaling the same information multiple times. Reference [8] proposes to include the AR SEI message with some minor modifications and bug fixes in the specification for SEI messages for VVC.

### SUMMARY

Certain challenges presently exist. For example, machine purposed tasks are currently performed on captured video or pictures by using one of the following means: a) encoding of the video or picture set followed by transmission and decoding them at the receiver side and then extracting the desired features from the decoded video or picture set at the receiver side using algorithms; and/or b) extracting the desired feature from the video or picture set at the capture side and transmitting the extracted features (compressed or non-compressed) to a receiver side for evaluation.

The first variant has the following disadvantages: if the video or picture is encoded lossless, then the bitrate will be high, and if lossy compression is used, the feature extraction after decoding might miss certain features due to lower quality of the decoded video or picture. The second variant has the disadvantage that there is no public standard available to carry this type of information and therefore it would not be possible to use encoders and decoders from different vendors. Also, as systems will likely communicate to units unknown to them, proprietary solutions might introduce unwanted communication problems. Other than interoperability issues, if only the desired features from the video or picture are extracted and communicated, there still might be a need for the video at the receiver side (e.g., for applications that might require occasional human inspection or might need the visual data as a backup solution). In this case, two communication channels are then required: one to communicate the information regarding the video or picture itself and another to communicate the extracted feature(s). In this case, the cost of two separate communication channels as well as the synchronization issues are undesirable.

This disclosure aims to overcome these disadvantages by combining a compressed video or picture with semantic information of that video or picture in one bitstream. Examples of the semantic information are features used in machine vision tasks. These features may be expressed by certain data types. In one example, supplementary information in the form of an SEI message is sent together with an encoded video or picture bitstream, where the SEI message carries information about the semantics of the video or picture content and semantics of the video or picture content are expressed in the form of labels, graphs, matrices or such.

Accordingly, in one aspect there is provided a method performed by a decoder. In one embodiment, the method includes the decoder receiving a plurality of Network Abstraction Layer, NAL, units, wherein the plurality of NAL units comprises: i) one or more Video Coding Layer, VCL, NAL units comprising pixel data for one or more pictures and ii) a first non-VCL NAL unit, characterized in that the first non-VCL NAL unit comprises: i) at least a first syntax element identifying at least a first data type, DT1, and ii) semantic information that comprises at least a first feature for one or more machine vision tasks, wherein the first feature comprises at least first data of the first data type. The method also includes the decoder obtaining the first feature from the first non-VCL NAL unit.

In another aspect there is provided a method performed by an encoder. In one embodiment, the method includes the encoder the encoder obtaining one or more pictures. The method also includes the encoder obtaining semantic information that comprises one or more features for one or more machine vision tasks, the one or more features comprising at least a first feature comprising at least first data of a first data type. The method also includes the encoder generating a plurality of Network Abstraction Layer, NAL, units, wherein the plurality of NAL units comprises: i) one or more Video Coding Layer, VCL, NAL units comprising pixel data for the one or more pictures and ii) a first non-VCL NAL unit, characterized in that the first non-VCL NAL unit comprises: i) at least a first syntax element identifying at least the first data type and ii) the semantic information.

In another aspect there is provided a computer program comprising instructions which when executed by processing circuitry of an apparatus causes the apparatus to perform the any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

An advantage of the embodiments disclosed herein is that they allow for using established video coding standards for communicating the visual content such as picture(s) or video and the semantics of the picture(s) or video in one bitstream. Semantics of the picture(s) or video may be expressed as features extracted from the visual content. Extracted features may be those being used in machine vision tasks such as object detection, object tracking, segmentation, etc. That is, for example, a single encoded video bitstream can carry the content for both human vison and machine vision. The embodiments can be used independently of the specific codec, as SEI messages can be used for different codecs without changing the syntax. Additionally, combining a compressed video or picture with semantic information provides the advantage of removing the need for synchronization between two communication channels—one for the visual content and another for the semantics of the visual content.

### BRIEF DESCRIPTION OF THE DRAWINGS

The accompanying drawings, which are incorporated herein and form part of the specification, illustrate various embodiments.

FIG. 1 illustrates a system according to an example embodiment.

FIG. 2 is a schematic block diagram of an encoding unit according to an embodiment.

FIG. 3 is a schematic block diagram of a decoding unit according to an embodiment.

FIG. 4 is a flowchart illustrating a process according to an embodiment.

FIG. 5 is a flowchart illustrating a process according to an embodiment.

FIG. 6 is a block diagram of an apparatus according to an embodiment.

### DETAILED DESCRIPTION

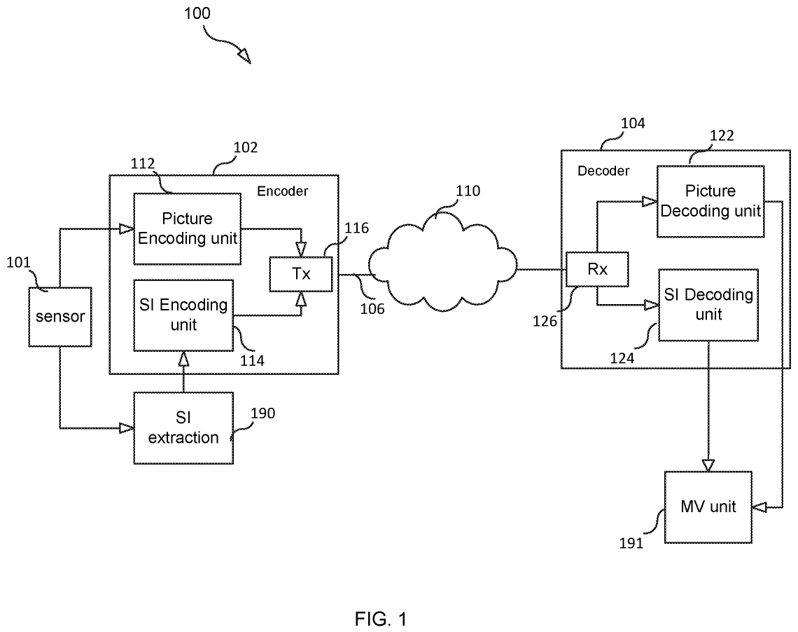

FIG. 1 illustrates a system 100 according to an example embodiment. System 100 includes a sensor 101 (e.g., image sensor) that provides image data corresponding to a single image (a.k.a., picture) or corresponding to a series of pictures (a.k.a., video) to a picture encoding unit 112 (e.g., a HEVC encoder or VVC encoder) of an encoder 102 that may be in communication with a decoder 104 via a network 110 (e.g., the Internet or other network). Encoding unit 112 encodes the image data to produce encoded image data, which may be encapsulated in VCL NAL units. The VCL NAL units are then provided to a transmitter 116 that transmits the VCL NAL units to decoder 104. Encoding unit 112 may also produce non-VCL NAL units that are transmitting in same bitstream 106 as the VCL NAL units. That is, the encoder 102 produces a bitstream 106 that is transmitted to decoder 104, where the bitstream comprises the encoded image data and non-VCL NAL units.

In the embodiments disclosed herein, the encoder 102 further obtains (e.g., receives or generates itself) semantic information (SI) about one or more pictures included in the bitstream and includes this SI in the bitstream with the encoded image data. For example, the encoder 102 in this example has an SI encoder 114 that obtains the SI from an SI extraction unit 190 (e.g., a neural network) and encodes the SI in a supplemental information unit (e.g., an SEI message contained in an SEI NAL unit) which is then transmitted via transmitter 116 to decoder 104 with the other NAL units. Thus, bitstream 106 includes NAL units containing encoded image data and supplemental information units (e.g., non-VCL NAL units) containing semantic information about one or more of the images from which the encoded image data was obtained. In some embodiments, the feature extraction unit comprise a neural network (NN) that is designed for a specific task, such as, for example, object detection or image segmentation. The output of the NN can be, for example, if the task is object detection, a list of bounding boxes indicating the positions of different objects. This data is referred to as a feature. In some embodiments the functionality of SI encoding unit 114 is performed by picture encoding unit 112. That is, for example, SI encoding unit 114 may be a component of picture encoding unit 112.

On the receiving end, decoder 104 comprises a receiver 126 that receives bitstream 106 and provides to picture decoding unit 122 the NAL units generated by picture encoding unit 112 and that provides to SI decoding unit 124 the non-VCL NAL units generated by SI encoding unit 114, which units comprise SI. In some embodiments the functionality of SI decoding unit 124 is performed by picture decoding unit 122. The picture decoding unit 122 produces decoded picture (e.g., video) that can then be used for human vision tasks like displaying video on a screen. SI decoding unit functions to decode the SI from the non-VCL NAL units and provide the SI (e.g., one or more features) to a machine vision, MV, unit 191 that is configured to use the SI to perform one or more MV tasks. Additionally, the decoded features can also be used to display additional information for human vision tasks.

There are several ways how the MV unit 191 can operate. For example, if no features are available, the MV unit 191 would operate similar to the feature extraction in the encoder and extract features from the decoded video. This is used as reference or baseline performance for the MPEG exploration in VCM. If both features and video are available, the MV unit 191 can refine the features transmitted using information from the decoded video. For example, if the original task was object detection and the transmitted features were a list of bounding boxes, the MV unit 191 could trace objects through different video frames. If only the features are available but no video, the MV unit 191 can pass the features to a quality assessment unit without further processing.

The quality assessment of human vision tasks can be done with various metrics commonly used in video compression, for example Peak Signal-to-Noise Ratio (PSNR) or MultiScale Structural SIMilarity (MS-SSIM) index. For the machine vision tasks, the quality assessment metrics depend on the task itself. Common metrics are for example mean average precision (mAP) for object detection or Multiple Object Tracking Accuracy (MOTA) for object tracking. Another factor that is evaluated in the performance assessment is the bitrate of the encoded bitstream, usually measured in bits per pixel (BPP) for images or kbps (kilobit per second) for video.

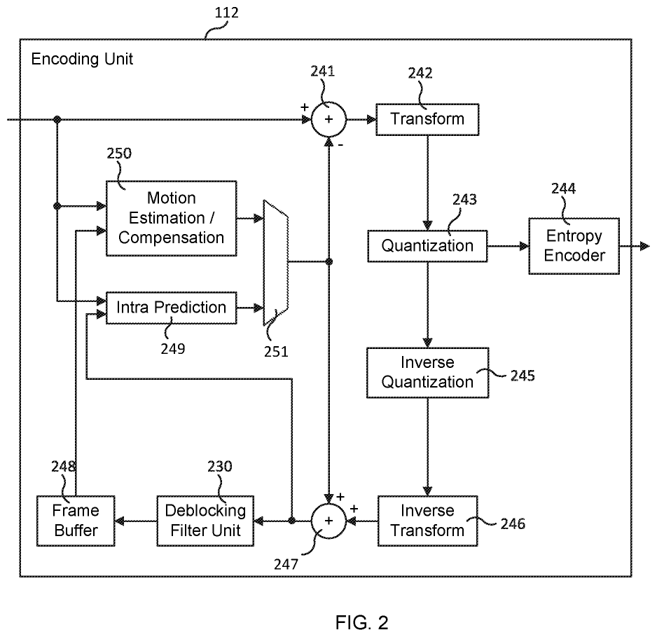

FIG. 2 is a schematic block diagram of encoding unit 112 for encoding a block of pixel values (hereafter “block”) in a video frame (picture) of a video sequence according to an embodiment. A current block is predicted by performing a motion estimation by a motion estimator 250 from an already provided block in the same frame or in a previous frame. The result of the motion estimation is a motion or displacement vector associated with the reference block, in the case of inter prediction. The motion vector is utilized by a motion compensator 250 for outputting an inter prediction of the block. An intra predictor 249 computes an intra prediction of the current block. The outputs from the motion estimator/compensator 250 and the intra predictor 249 are input in a selector 251 that either selects intra prediction or inter prediction for the current block. The output from the selector 251 is input to an error calculator in the form of an adder 241 that also receives the pixel values of the current block. The adder 241 calculates and outputs a residual error as the difference in pixel values between the block and its prediction. The error is transformed in a transformer 242, such as by a discrete cosine transform, and quantized by a quantizer 243 followed by coding in an encoder 244, such as by entropy encoder. In inter coding, also the estimated motion vector is brought to the encoder 244 for generating the coded representation of the current block. The transformed and quantized residual error for the current block is also provided to an inverse quantizer 245 and inverse transformer 246 to retrieve the original residual error. This error is added by an adder 247 to the block prediction output from the motion compensator 250 or the intra predictor 249 to create a reference block that can be used in the prediction and coding of a next block. This new reference block is first processed by a deblocking filter unit 230 according to the embodiments in order to perform deblocking filtering to combat any blocking artifact. The processed new reference block is then temporarily stored in a frame buffer 248, where it is available to the intra predictor 249 and the motion estimator/compensator 250.

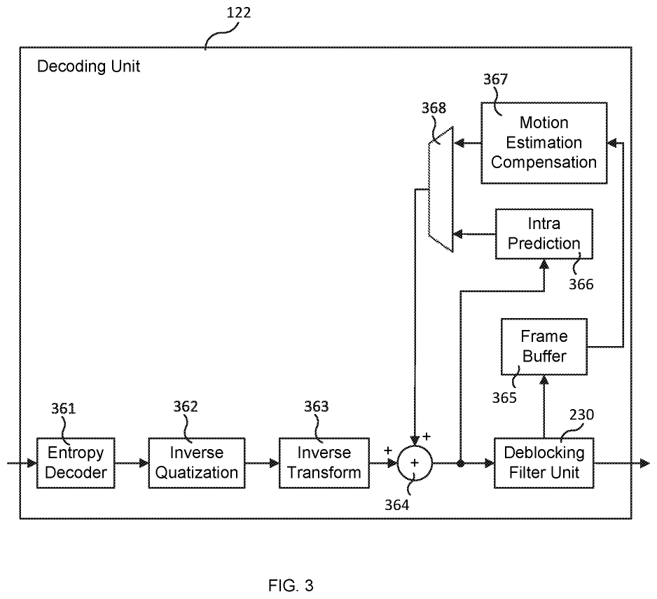

FIG. 3 is a corresponding schematic block diagram of decoding unit 122 according to some embodiments. The decoding unit 122 comprises a decoder 361, such as entropy decoder, for decoding an encoded representation of a block to get a set of quantized and transformed residual errors. These residual errors are dequantized in an inverse quantizer 362 and inverse transformed by an inverse transformer 363 to get a set of residual errors. These residual errors are added in an adder 364 to the pixel values of a reference block. The reference block is determined by a motion estimator/compensator 367 or intra predictor 366, depending on whether inter or intra prediction is performed. A selector 368 is thereby interconnected to the adder 364 and the motion estimator/compensator 367 and the intra predictor 366. The resulting decoded block output form the adder 364 is input to a deblocking filter unit 230 according to the embodiments in order to deblocking filter any blocking artifacts. The filtered block is output form the decoder 504 and is furthermore preferably temporarily provided to a frame buffer 365 and can be used as a reference block for a subsequent block to be decoded. The frame buffer 365 is thereby connected to the motion estimator/compensator 367 to make the stored blocks of pixels available to the motion estimator/compensator 367. The output from the adder 364 is preferably also input to the intra predictor 366 to be used as an unfiltered reference block.

Including Semantic Information in the Video Bitstream 106

Semantic information is information related to the content of a picture or video, the labels, positioning and relation between the objects in the picture or video, pixel groups that have some defined relation to each other in the picture or video, etc. The semantic information may include picture or video features used for machine vision tasks. As noted above, encoder 102 uses supplemental information units (e.g., SEI messages) to convey information that can be used for machine vision tasks. This disclosure uses the term supplemental information unit as a general term for a container format that enables sending semantic information for a picture or video as information blocks (e.g. NAL units) in a coded bitstream.

As there are different machine vision tasks the data types of semantic information (e.g., features) might differ significantly. Data types might be for example pixel coordinates, position boxes, labels, graphs, matrices, etc.

It is possible to create the semantic information that is being conveyed manually, for example the ground truth annotations are in many cases generated by hand. In most cases, however, algorithms such as neural networks are used to extract the features. Also, in many applications it is not feasible to extract features manually as the response times are too slow and manual feature extraction costs too high compared to algorithms.

Since the data handled by the encoder and decoder varies and is dependent on the application, different data types need to be handled by different algorithms. One way to solve this is to have different SEI messages for different data types and each SEI message could carry data of one specific type. Another solution would be to carry different data types in a single SEI message. In this case the SEI message could include a syntax element indicating which type of data the message is carrying.

In some applications it may be required to run different tasks for the same picture to get multiple data types associated with the same input data. One way to solve this could be to send multiple SEI messages for the same picture. However, it should also be possible to send different data types in the same SEI message. This could save some overhead if the amount of data is very small (e.g. an identifier from an event detection algorithms) since the header only needs to be transmitted once. Technically, one way of solving this issue is to send the total number of data types before sending the actual data. Another solution is to include a syntax element in the data indicating whether another data type follows the current data type or if the end of the SEI message is reached.

An SEI message can have a varying persistence scope which can span from a single picture to an entire video. Due to the nature of the data transmitted in the scope of VCM, each SEI message may be associated with a single picture of a video or a specific picture. In this case, the SEI message may contain an identifier to signal which picture the conveyed information belongs to. However, if the framerate of the video stream is too high for the feature extraction, it is possible to associate extracted features with several frames of the video. This might be reasonable for example where objects do not significantly change their position from frame to frame. The SEI could contain two related syntax elements:

1) a picture order count (POC), which associates an SEI message with a specific picture. The corresponding picture should ideally have the same POC, and
2) a flag indicating whether the data contained in the SEI message may be used for several pictures; for example, if the flag is set to true, the data will remain valid until a new SEI is received, and if the flag is false, the data is valid only for the associated picture (for example determined by the POC).

The following embodiments capture different elements of this disclosure which elements may be used individually or as a combination.

1. Semantics SEI

This embodiment adds information about the content of a video or picture such as the semantics of the video or picture to the encoded bitstream of the video or picture as supplemental information, e.g. in the form of an SEI message. The semantics of the video or picture may be expressed in the form of features which may in turn be specified using data types such as pixel coordinates, position boxes, labels, graphs, matrices or other data types.

In one example, the information about the content of a video or picture such as the semantics of the video or picture are encoded as information blocks (e.g. NAL units) into the coded bitstream as supplemental information in a way that those information blocks (e.g. NAL units) can be removed without hindering the decoding of the rest of the bitstream to obtain the decoded video or picture.

The scope of the supplemental information (e.g. the SEI message) may be all or part of the bitstream including the example of the SEI validity until a new SEI.

2. General VCM SEI

This embodiment is similar to embodiment 1 but is particular to the case where the information about the semantics of an associated video or picture includes one or more features of the associated video or picture(s) used for one or more machine vision tasks such as those in the scope of VCM. Examples of features in this embodiment may include: 1) Bounding boxes used for e.g. object detection; 2) Text including object labelling, image semantics; 3) Object trajectories; 4) Segmentation maps; 5) Depth maps; 6) Events used in e.g. event detection or prediction. The scope of the supplemental information (e.g. the SEI message) may be all or part of the bitstream including the example of the SEI validity until a new SEI.

3: Data from an Algorithm, e.g. a Neural Network

In this embodiment the data that is conveyed in the supplemental information (e.g. the SEI message) is generated by an algorithm, e.g. a neural network. In a variant of this embodiment, one or more parameters related to the data generating algorithm are also send in the supplemental information (e.g. SEI message).

4. More than One Encoding-Decoding Algorithm

In one embodiment, different encoding/decoding algorithms are used for different data types. In one example, a first neural network (NN1) is used for generating a first data type, DT1, and a second neural network (NN2) is used for generating a second data type (DT2), and both DT1 and DT2 are conveyed in the same SEI message. In a different example, NN1 is used for generating data of type DT1 and data of type DT2.

5. Multi Feature Types SEI

In this embodiment the supplementary information (e.g. the SEI message) contains a syntax element indicating what kind of data type is conveyed in the supplementary information unit (e.g. the SEI message). In one example, a first syntax element S1 is signalled in a first supplementary information unit SEI1, where i) when syntax element S1 is equal to a first value S1 indicates that data of data type DT1 is conveyed in SEI1 and ii) when syntax element S1 is equal to a second value S1 indicates that data of data type DT2 is conveyed in SEI1. In this embodiment, several data types can be sent. In a variant of this embodiment, for different data types, different encoding/decoding algorithms are used.

6. Multi-Data SEI

This embodiment is an extension of embodiment 5, but one unit of supplemental information (e.g. one SEI message) may contain several different data types, e.g. DT1 and DT2. This may be indicated in various ways, including:

1) by signalling a syntax element S1 in a unit of supplemental information (e.g. a SEI message) determining how many data types are signalled in the unit of supplemental information (e.g. the SEI message); in one example, S1 equal to the value n indicates that n data types DT1, . . . , DTn are signalled in the unit of supplemental information (e.g. the SEI message), where n is be an integer greater than 1;
2) by signalling a syntax element S2 indicating whether the current data type is the last one contained in the current unit of supplemental information (e.g. a current SEI message); in one example, after decoding all data of data type DT1, S2 is evaluated and corresponding to S2 being equal to a first value, another data type DT2 is decoded, and corresponding to S2 being equal to a second value, no further data type is decoded; and 3) by signalling a set of syntax elements f1, . . . , fn in a unit of supplemental information (e.g. a SEI message), where each of them equal to a first value indicates that the corresponding data type DT[i] is signalled in the unit of supplemental information (e.g. the SEI message) and each of them equal to a second value indicates that the corresponding data type DT[i] is not signalled in the unit of supplemental information (e.g. the SEI message); in one example, each of f1, . . . , fn may be a one bit flag.

7. Persistence Scope of an SEI

In this embodiment the persistence scope of the supplementary information (e.g. the SEI message) is described. Semantics of the video or picture might change from one frame to another or may stay unchanged during several frames or be defined for or applied to only some of the frames in the video, e.g. only the intra-coded frames or e.g. every n-th frame for high frame rates or slow motion videos. Correspondingly, the persistence scope of the supplementary information unit carrying information about semantics of the video or picture content may be only one frame or more.

In one example, the persistence scope of one unit of supplementary information is an entire bitstream. In another example, the persistence scope of one unit of supplementary information is until a new unit of supplementary information in the bitstream. In another example, the persistence scope of one unit of supplementary information is a single frame or picture. In another example the persistence scope of one unit of supplementary information is specified explicitly e.g. every n-th frame, frames with a particular frame type (such as “I” frame or “B” frame), or another subset of frames. In yet another example, the persistence scope of a first unit of supplementary information is overwritten (e.g. extended) by a second unit of supplementary information, which only updates the persistence scope of the first unit of supplementary information without repeating the features or data types in the first unit of supplementary information.

The persistence scope of the supplementary information may be specified by signaling a picture order count (POC) value inside the supplemental information unit (e.g. SEI NAL unit). In one example, a first picture order count value (POC1) is signaled in a supplemental information unit and the persistence scope of the supplementary information is defined as the video frame or picture with POC equal to POC1. In another example, the persistence scope of the supplementary information is defined as the video frame or picture with POC greater than or equal to POC1

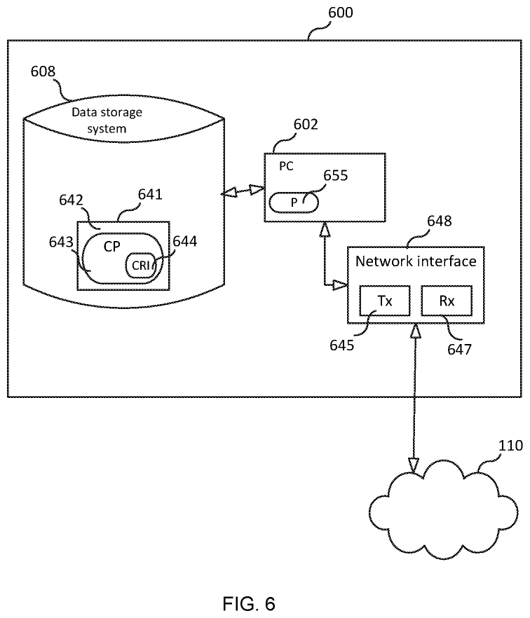

FIG. 6 is a block diagram of an apparatus 600 for implementing decoder 104 and/or encoder 102, according to some embodiments. When apparatus 600 implements a decoder, apparatus 600 may be referred to as a “decoding apparatus 600,” and when apparatus 600 implements an encoder, apparatus 600 may be referred to as an “encoding apparatus 600.” As shown in FIG. 6, apparatus 600 may comprise: processing circuitry (PC) 602, which may include one or more processors (P) 655 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 600 may be a distributed computing apparatus); at least one network interface 648 comprising a transmitter (Tx) 645 and a receiver (Rx) 647 for enabling apparatus 600 to transmit data to and receive data from other nodes connected to a network 110 (e.g., an Internet Protocol (IP) network) to which network interface 648 is connected (directly or indirectly) (e.g., network interface 648 may be wirelessly connected to the network 110, in which case network interface 648 is connected to an antenna arrangement); and a storage unit (a.k.a., “data storage system”) 608, which may include one or more non-volatile storage devices and/or one or more volatile storage devices. In embodiments where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes apparatus 600 to perform steps described herein (e.g., steps described herein with reference to the flow charts). In other embodiments, apparatus 600 may be configured to perform steps described herein without the need for code. That is, for example, PC 602 may consist merely of one or more ASICs. Hence, the features of the embodiments described herein may be implemented in hardware and/or software.

### Summary of Various Embodiments

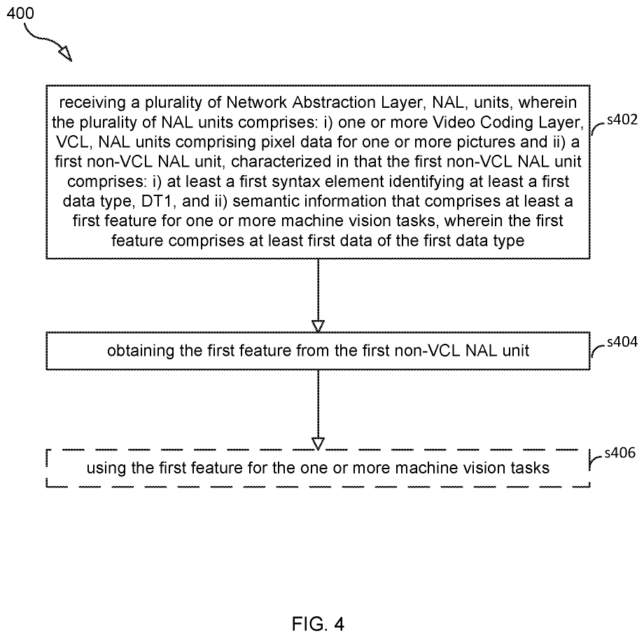

A1. A method 400 (see FIG. 4), the method comprising: a decoder receiving (step s402) a plurality of Network Abstraction Layer, NAL, units, wherein the plurality of NAL units comprises: i) one or more Video Coding Layer, VCL, NAL units comprising pixel data for one or more pictures and ii) a first non-VCL NAL unit, characterized in that the first non-VCL NAL unit comprises: i) at least a first syntax element identifying at least a first data type, DT1, and ii) semantic information that comprises at least a first feature for one or more machine vision tasks, wherein the first feature comprises at least first data of the first data type; and the decoder obtaining (step s404) the first feature from the first non-VCL NAL unit.

A2. The method of embodiment A1, wherein obtaining the first features from the first non-VCL NAL unit comprises the decoder obtaining the first feature from the first non-VCL NAL unit using the first syntax element.

A3. The method of embodiment A1 or A2, further comprising: after obtaining the first feature from the first non-VCL NAL unit, using (step s406) the first feature for the one or more machine vision tasks.

A4. The method of embodiment A3, wherein the one or more machine vision tasks is one or more of: object detection, object tracking, picture segmentation, event detection, or event prediction.

A5. The method of embodiment A3 or A4, wherein using the first feature for the one or more machine vision tasks comprises using the first feature and the one or more pictures to produce a refined picture.

A6. The method of any one of embodiments A1-A5, wherein the first feature is extracted from the one or more pictures.

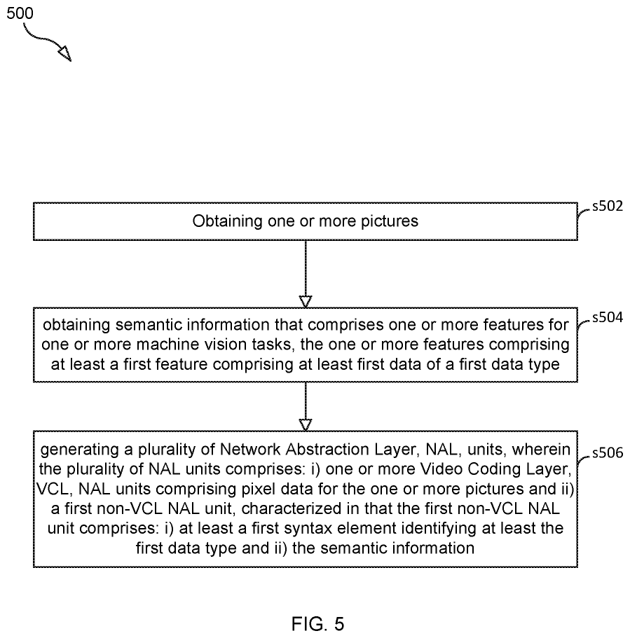

B1. A method 500 (see FIG. 5), the method comprising: an encoder obtaining (step s502) one or more pictures; the encoder obtaining (step s504) semantic information that comprises one or more features for one or more machine vision tasks, the one or more features comprising at least a first feature comprising at least first data of a first data type; and the encoder generating (step s506) a plurality of Network Abstraction Layer, NAL, units, wherein the plurality of NAL units comprises: i) one or more Video Coding Layer, VCL, NAL units comprising pixel data for the one or more pictures and ii) a first non-VCL NAL unit, characterized in that the first non-VCL NAL unit comprises: i) at least a first syntax element identifying at least the first data type and ii) the semantic information.

B2. The method of embodiment B1, wherein the one or more machine vision tasks include: object detection, object tracking, picture segmentation, event detection, and/or event prediction.

B3. The method of embodiment B1 or B2, wherein the one or more features were extracted from the one or more pictures.

C1. The method of any one of the above embodiments, wherein the first data of the first feature comprises: information identifying a bounding box indicating a size and a position of an object in one of the pictures, type information identifying the object's type, a label for a detected object, a timestamp indicating a time at which an event is predicted to occur, information indicating an objects trajectory, a segmentation map, a depth map, and/or text describing a detected event.

C2. The method of embodiment C1, wherein the first feature further comprises pixel coordinates that identify the position of the object.

C3. The method of any one of the above embodiments, wherein the first non-VCL NAL unit is a Supplementary Enhancement Information, SEI, NAL unit that comprises an SEI message that comprises the semantic information.

C4. The method of any one of the above embodiments, wherein the first non-VCL NAL unit further comprises picture information identifying one or more pictures from which the first feature was extracted.

C5. The method of embodiment C4, wherein the picture information is a picture order count, POC, that identifies a single picture.

C6. The method of embodiment C4, wherein the picture information comprises a second syntax element and the second syntax element equal to a first value indicates that the first feature applies to multiple pictures and the second syntax element equal to a second value indicates that the first feature applies to one picture.

C6b. The method of embodiment C6, wherein the second syntax element is a flag.

C7. The method of any one of the above embodiments, wherein the first feature is generated by a neural network.

C8. The method of any one of the above embodiments, wherein the semantic information further comprises a second feature.

C9. The method of embodiment C8, wherein the first feature is produced by a first neural network, NN1, and the second feature is produced by NN1 or by a second neural network, NN2.

C10. The method of embodiment C8 or C9, wherein the second feature comprises second data of a second data type, DT2.

C11. The method of embodiment C10, wherein the first non-VCL NAL unit further comprises a third syntax element that identifies the data type of the second data.

C12. The method of any one of the above embodiments, wherein the first non-VCL NAL unit comprises a fourth syntax element and the fourth syntax element equal to a first value indicates that N data types are included in the semantic information, where N is greater than 1.

C13. The method of any one of the above embodiments, wherein the semantic information has a persistence scope, and the persistence scope is an entire bitstream or until a second non-VCL NAL unit comprising second semantic information is detected.

C14. The method of any one of the above embodiments, wherein the semantic information has a persistence scope and the persistence scope is a single picture.

C15. The method of any one of embodiments A1-A6 or C1-C14, wherein the semantic information has an initial persistence scope, and the method further comprises the decoder receiving a second non-VCL NAL unit that indicates to the decoder that the decoder should extend the initial persistence scope of the semantic information.

C16. The method of any one of embodiments B1-B3 or C1-C15, wherein the semantic information has an initial persistence scope, and the method further comprises the encoder generating a second non-VCL NAL unit that indicates that the initial persistence scope should be extended.

D1. A computer program 643 comprising instructions 644 which when executed by processing circuitry 602 causes the processing circuitry 602 to perform the method of any one of the above embodiments.

D2. A carrier containing the computer program of embodiment D1, wherein the carrier is one of an electronic signal, an optical signal, a radio signal, and a computer readable storage medium 642.

E1. An apparatus 600, the apparatus being adapted to perform the method of any one of the above embodiments.

E2. The apparatus 600 of embodiment E1, wherein the apparatus is an encoding apparatus, and the encoding apparatus comprises a picture encoding unit 112, wherein the picture encoding unit is configured to encode image data corresponding to the one or more pictures to produce the pixel data and is further configured to encode the one or more features extracted from the one or more pictures.

E3. The apparatus 600 of embodiment E2, wherein the picture encoding unit is further configured to extract the one or more features from the one or more pictures.

E4. The apparatus 600 of embodiment E1, wherein the apparatus is a decoding apparatus, and the decoding apparatus comprises a picture decoding unit 122, wherein the picture decoding unit 122 is configured to decode the pixel data to produce one or more decoded pictures and is further configured to decode the semantic information from the first non-VCL NAL unit.

F1. An apparatus 600, the apparatus comprising: processing circuitry 602; and a memory 642, said memory containing instructions 644 executable by said processing circuitry, whereby said apparatus is operative to perform the method of any one of the above embodiments.

### CONCLUSION

As the above demonstrates, encoder 102 is advantageously operable to include within supplemental information units (e.g. SEI messages) that are part of a video or picture bitstream semantic information (e.g., features extracted by semantic information (SI) extraction unit 190) that describes semantics of the video or picture content carried in the bitstream, which features can be used in, for example, machine vision tasks. Likewise, decoder 104 is operable to receive the bitstream containing the supplemental information units and well as other NAL units (i.e., VCL NAL units that contain data representing an encoded image), obtain the supplemental information units from the bitstream, decode the semantic information from the supplemental information units, provide the supplemental information to, for example, a machine vision unit 197.

Advantageously, the supplemental information units may be configured to signal more than one data type used for describing features in machine vision tasks. Additionally, specific information about the content of a supplemental information unit (e.g. SEI messages) can be included as part of the unit. For example, one or more syntax elements are included in the supplemental information unit and these one or more syntax elements indicate what data type is carried in the supplemental information unit or how many data types are contained in the supplemental information unit. Furthermore, the persistence scope of a first supplemental information unit can be adjusted (ended or extended) using a second supplemental information unit without repeating the features or data types of the first supplemental information unit in the second supplemental information unit.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] B. Bross, J. Chen, S. Liu, “Versatile Video Coding (Draft 9)”, Output document approved by JVET, document number JVET-R2001.
[2] J. Boyce, V. Drugeon, G. J. Sullivan, Y.-K. Wang, “Supplemental enhancement information messages for coded video bitstreams (Draft 4)”, Output document approved by JVET, document number JVET-R2007-v2.
[3] MPEG Requirements. Use cases and requirements for Video Coding for Machines. MPEG document w19365, April 2020.
[4] P. Cerwall (executive editor), et al. Ericsson Mobility Report. https://www.ericsson.com/en/mobility-report. November 2019.
[5] W. Zhang, L. Yang, L. Duan, M. Rafie. SEI Message for CDVA Deep Feature Descriptor. MPEG document m53429, April 2020.
[6] MPEG Requirements. Evaluation Framework for Video Coding for Machines. MPEG document w19366, April 2020.
[7] J. Boyce, P. Guruva Reddiar. Object tracking SEI message (now Annotated region SEI message). JCTVC-AE0027, April 2018.
[8] J. Boyce, P. Guruva Reddiar. AHG9: VVC and VSEI Annotated Regions SEI message. JVET-T0053, October 2020.

### Abbreviations

AU Access Unit

BPP Bits per pixel

CDVA Compact Descriptors for Video Analysis

CDVS Compact Descriptors for Visual Search

CfE Call for Evidence

CfP Call for Proposals

HEVC High Efficiency Video Coding

JVET Joint Video Experts Team

kbps Kilobit per second

mAP Mean Average Precision

MOTA Multiple Object Tracking Accuracy

MPEG Moving Picture Experts Group

MS-SSIM MultiScale Structural SIMilarity

NAL Network Access Layer

POC Picture Order Count

PSNR Peak Signal-to-Noise Ratio

RBSP Raw Byte Sequence Payload

SEI Supplemental Enhancement Information

VCL Video Coding Layer

VCM Video Coding for Machines

VVC Versatile Video Coding

VUI Video Usability Information

1. A method, the method comprising:
a decoder receiving a plurality of Network Abstraction Layer (NAL) units, wherein the plurality of NAL units comprises: i) one or more Video Coding Layer (VCL) NAL units comprising pixel data for one or more pictures and ii) a first non-VCL NAL unit, characterized in that the first non-VCL NAL unit comprises: i) at least a first syntax element identifying at least a first data type and ii) semantic information that comprises at least a first feature for one or more machine vision tasks, wherein the first feature comprises at least first data of the first data type; and
the decoder obtaining the first feature from the first non-VCL NAL unit.

2. The method of claim 1, wherein obtaining the first features from the first non-VCL NAL unit comprises the decoder obtaining the first feature from the first non-VCL NAL unit using the first syntax element.

3. The method of claim 1, further comprising:
after obtaining the first feature from the first non-VCL NAL unit, using the first feature for the one or more machine vision tasks.

4. The method of claim 3, wherein the one or more machine vision tasks is one or more of: object detection, object tracking, picture segmentation, event detection, or event prediction.

5. The method of claim 3, wherein using the first feature for the one or more machine vision tasks comprises using the first feature and the one or more pictures to produce a refined picture.

6. The method of claim 1, wherein the first feature is extracted from the one or more pictures.

7. A method, the method comprising:
an encoder obtaining one or more pictures;
the encoder obtaining semantic information that comprises one or more features for one or more machine vision tasks, the one or more features comprising at least a first feature comprising at least first data of a first data type; and
the encoder generating a plurality of Network Abstraction Layer (NAL) units, wherein the plurality of NAL units comprises: i) one or more Video Coding Layer (VCL) NAL units comprising pixel data for the one or more pictures and ii) a first non-VCL NAL unit, characterized in that the first non-VCL NAL unit comprises: i) at least a first syntax element identifying at least the first data type and ii) the semantic information.

8. The method of claim 7, wherein the one or more machine vision tasks include: object detection, object tracking, picture segmentation, event detection, and/or event prediction.

9-11. (canceled)

12. The method of claim 1, wherein the first non-VCL NAL unit is a Supplementary Enhancement Information (SEI) NAL unit that comprises an SEI message that comprises the semantic information.

13. The method of claim 1, wherein the first non-VCL NAL unit further comprises picture information identifying one or more pictures from which the first feature was extracted.

14. The method of claim 13, wherein the picture information is a picture order count (POC) that identifies a single picture.

15. The method of claim 13, wherein the picture information comprises a second syntax element and the second syntax element equal to a first value indicates that the first feature applies to multiple pictures and the second syntax element equal to a second value indicates that the first feature applies to one picture.

16-26. (canceled)

27. A non-transitory computer readable storage medium storing a computer program comprising instructions which when executed by processing circuitry of an apparatus causes the apparatus to perform the method of claim 1.

28. A non-transitory computer readable storage medium storing a computer program comprising instructions which when executed by processing circuitry of an apparatus causes the apparatus to perform the method of claim 7.

29-32. (canceled)

33. An apparatus, the apparatus comprising:
processing circuitry; and
a memory containing instructions executable by the processing circuitry, wherein the apparatus is configured to perform the method of claim 1.

34. An apparatus, the apparatus comprising:
processing circuitry; and
a memory containing instructions executable by the processing circuitry, wherein the apparatus is configured to perform the method of claim 7.
